(19) United States
(12) Patent Application Publication
(10) Pub. No.: US 2014/0159603 A1
(43) Pub. Date: Jun. 12, 2014

(54) LED DRIVING APPARATUS AND METHOD

(71) Applicant: SAMSUNG ELECTRO-MECHANICS CO., LTD., Suwon (KR)

(72) Inventors: Keun Wook LEE, Suwon (KR); Byoung Woo RYU, Suwon (KR); Hong Sun PARK, Suwon (KR); Heung Gyoon CHOI, Suwon (KR)

(73) Assignee: SAMSUNG ELECTRO-MECHANICS CO., LTD., Suwon (KR)

(21) Appl. No.: 13/866,771

(22) Filed: Apr. 19, 2013

(30) Foreign Application Priority Data
Dec. 7, 2012 (KR) 10-2012-0141989

(51) Int. Cl. H05B 33/08

(52) U.S. Cl. CPC H05B 33/0824
USPC 315/200 R

(57) ABSTRACT

There are provided an LED driving apparatus and an LED driving method. The LED driving apparatus includes a rectifying unit rectifying AC power; a light emitting unit including a plurality of light emitting diodes; a switching unit including a plurality of switching elements connected to the plurality of light emitting diodes; and a controlling unit controlling operations of the plurality of light emitting diodes, wherein the controlling unit controls a duty ratio of a turned-on switching element based on a level of the AC power within respective turning-on periods of the plurality of switching elements.

### CROSS-REFERENCE TO RELATED APPLICATIONS

This application claims the priority of Korean Patent Application No. 10-2012-0141989 filed on Dec. 7, 2012, in the Korean Intellectual Property Office, the disclosure of which is incorporated herein by reference.

### BACKGROUND OF THE INVENTION

1. Field of the Invention

The present invention relates to an LED driving apparatus and an LED driving method capable of reducing a ripple in average current applied to LEDs to thereby reduce current stress on the LEDs, by controlling a duty ratio of a switching element turned on when respective LEDs emit light according to a level of AC power, in an LED driving apparatus for driving LEDs by directly applying AC power to LEDs without an AC-DC converter.

2. Description of the Related Art

Light emitting diodes (LEDs), semiconductor devices having a p-n junction structure and emitting light through the recombination of electrons and holes, have been applied for use in a wide range of fields with the recent development of semiconductor technology. Particularly, since LEDs have high efficiency, a relatively long lifespan, and eco-friendly characteristics, as compared with a light emitting device according to the related art, fields of application thereof tend to be continuously expanded.

In general, LEDs may be driven through the application of direct current (DC) power having a level of several volts, and accordingly, a separate unit is required in order to drive LEDs with a commercial alternating current (AC) power which is generally used domestically or commercially. In order to drive LEDs with a commercial AC power, an LED driving apparatus generally includes a rectifier circuit, an AC-DC converter, and the like.

However, since a general AC-DC converter commonly has a large volume and high power consumption, when a general AC-DC converter is applied to an LED driving apparatus, advantages of LED such as high efficiency, a small package size, and a relatively long lifespan are largely attenuated. Accordingly, recently, a large amount of research into an apparatus able to directly drive LEDs with AC power, without an AC-DC converter, has been undertaken. In the case of directly driving LEDs with AC power, without an AC-DC converter, the following method may be generally used: a plurality of switches are connected to a plurality of LEDs and current flows uniformly by controlling on/off switching of the plurality of switches according to a level of AC power.

Patent Document 1 relates to an LED driving apparatus directly driving LEDs with AC power by controlling the operation of switches connected to intermediate and last nodes of an LED array. Patent Document 2 relates to an LED driving apparatus and discloses a configuration of controlling on/off switching of switches in a connected order of an LED array. However, Patent Documents 1 and 2 fail to disclose controlling the operation of switches according to a level of AC power, and particularly, controlling a duty ratio of a turned-on switch according to the level of AC power.

### RELATED ART DOCUMENT

(Patent Document 1) Korean Patent No. KR 10-0997050
(Patent Document 2) Korean Patent No. KR 10-0995793

### SUMMARY OF THE INVENTION

An aspect of the present invention provides an LED driving apparatus and an LED driving method in which a plurality of switching elements connected to a plurality of LEDs are turned on or off according to a level of AC power, respectively. In particular, an aspect of the present invention provides an LED driving apparatus and an LED driving method capable of reducing a ripple component in average current applied to LEDs to thereby reduce current stress applied to the LEDs, by increasing or decreasing a duty ratio of a turned-on switching element according to a level of AC power.

According to an aspect of the present invention, there is provided an LED driving apparatus, including: a rectifying unit rectifying AC power; a light emitting unit including a plurality of light emitting diodes; a switching unit including a plurality of switching elements connected to the plurality of light emitting diodes; and a controlling unit controlling operations of the plurality of light emitting diodes, wherein the controlling unit controls a duty ratio of a turned-on switching element based on a level of the AC power within respective turning-on periods of the plurality of switching elements.

The controlling unit may control respective turning-on and turning-off operations of the plurality of switching elements based on the level of the AC power.

The plurality of switching elements may be connected to respective cathodes of the plurality of light emitting diodes.

The controlling unit may control the remainder of the plurality of switching elements to be turned off when one of the plurality of switching elements is turned on. The controlling unit may control the duty ratio of the turned-on switching element to be inversely proportional to the level of the AC power.

The controlling unit may include a comparator comparing the level of the AC power with a predetermined reference voltage; a calculator calculating a current detection signal obtained by detecting current flowing in the plurality of light emitting diodes and an output signal of the comparator; and a control signal generator generating respective control signals for the plurality of switching elements based on the calculated result of the calculator.

The control signal generator may generate a control signal having a low duty ratio when the level of the AC power is increased, and generates a control signal having a high duty ratio when the level of the AC power is decreased.

According to another aspect of the present invention, there is provided an LED driving method, including: rectifying AC power; detecting a level of the rectified AC power; controlling respective turning-on and turning-off operations of a plurality of switching elements connected to a plurality of light emitting diodes based on the level of the AC power; and controlling a duty ratio of a turned-on switching element among the plurality of switching elements based on the level of the AC power.

In the controlling of the duty ratio, when the level of the AC power is increased, the duty ratio may be decreased so that a conduction time of the switching element may be decreased, and when the level of the AC power is decreased, the duty ratio may be increased so that the conduction time of the switching element may be increased.

In the controlling of the turning-on and turning-off operations, one of the plurality of switching elements may be turned on according to the level of the AC power and the remainder of the plurality of switching elements may be turned off.

In the controlling of the turning-on and turning-off operations, the plurality of switching elements may be sequentially turned on according to the level of the AC power.

According to yet another aspect of the present invention, there is provided an LED driving apparatus for driving an LED array including a plurality of light emitting diodes driven with AC power, the LED driving apparatus including: a switching unit including a plurality of switching elements connected to a plurality of nodes included in the LED array; and a controlling unit controlling respective operations of the plurality of switching elements according to a level of the AC power, wherein the controlling unit controls a duty ratio of a turned-on switching element within respective turning-on periods of the plurality of switching elements.

The controlling unit may control the remainder of the plurality of switching elements to be turned off when one of the plurality of switching elements is turned on. The controlling unit may decrease the duty ratio of the turned-on switching element when the level of the AC power is increased, and increase the duty ratio of the turned-on switching element when the level of the AC power is decreased.

The controlling unit may control the respective operations of the plurality of switching elements such that the plurality of switching elements may be sequentially turned on.

The controlling unit may include a comparator comparing the level of the AC power with a predetermined reference voltage; a calculator calculating a current detection signal obtained by detecting current flowing in the light emitting diodes and an output signal of the comparator; and a control signal generator generating respective control signals for the plurality of switching elements based on the calculated result of the calculator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating an LED driving apparatus according to an embodiment of the present invention;

FIG. 2 is a circuit diagram illustrating an LED driving apparatus according to an embodiment of the present invention;

FIGS. 3 through 6 are graphs illustrating an operation of an LED driving apparatus according to an embodiment of the present invention;

FIG. 7 is a circuit diagram illustrating an example of a controlling unit of an LED driving apparatus according to an embodiment of the present invention in detail; and

FIG. 8 is a flowchart illustrating an LED driving method according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same or like reference numerals will be used to designate the same or like elements.

Hereinafter, embodiments of the present invention will be described in detail with reference to the accompanying drawings so that those skilled in the art may easily practice the present invention.

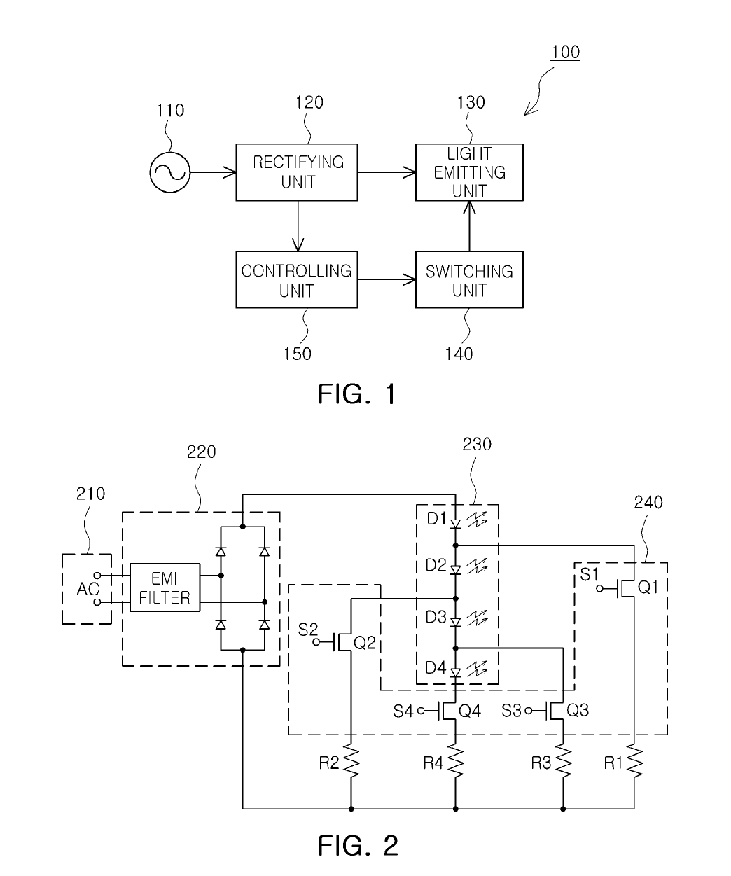

FIG. 1 is a block diagram illustrating an LED driving apparatus according to an embodiment of the present invention.

Referring to FIG. 1, an LED driving apparatus 100 according to the embodiment of the present invention may include a power supply unit 110 outputting alternating current (AC) power, a rectifying unit 120 rectifying the AC power, a light emitting unit 130 including a plurality of LEDs, a switching unit 140 controlling the operation of the plurality of LEDs, and a controlling unit 150 controlling the operation of the switching unit 140. The power supply unit 110 may output predetermined AC power, for example, commercial AC power of 220V/60 Hz.

The rectifying unit 120 may include a rectifying circuit rectifying the commercial AC power output by the power supply unit 110, and the rectifying circuit may be configured of a diode bridge including a plurality of diodes. A signal output by the rectifying unit 120 is half-wave or full-wave rectified AC power, and in the present embodiment, the AC signal output by the rectifying unit 120 is directly applied to a plurality of LEDs included in the light emitting unit 130 as a driving signal, without passing through an AC-DC converter.

The light emitting unit 130 may include an LED array configured of the plurality of LEDs. A light emitting operation of the plurality of LEDs included in the light emitting unit 130 may be controlled by turning on or off of each of a plurality of switching elements included in the switching unit 140, and the turning-on or off operation of the individual switching elements may be controlled by the controlling unit 150. The controlling unit 150 detects a level of the AC signal output by the rectifying unit 120 to control the turning-on and off operation of individual switching elements included in the switching unit 140 and a duty ratio of a turned-on switching element. Hereinafter, an embodiment of the present invention will be described with reference to FIGS. 2 through 6.

FIG. 2 is a circuit diagram illustrating an LED driving apparatus according to an embodiment of the present invention.

Referring to FIG. 2, an LED driving apparatus 200 according to the present embodiment includes a power supply unit 210 outputting AC power, a rectifying unit 220, alight emitting unit 230, and a switching unit 240. An operation of a plurality of switching elements Q1 to Q4 included in the switching unit 240 is controlled by control signals S1 to S4 output by a controlling unit (not illustrated). As described above, the rectifying unit 220 may include a diode bridge configured of four diodes, and may further include an EMI filter for selectively filtering the AC power output by the power supply unit 210. Meanwhile, in the present embodiment, it is assumed that the light emitting unit 230 includes four LEDs D1 to D4 and the switching unit 240 includes four switching elements Q1 to Q4; however, a different circuit configuration may be implemented in another embodiment.

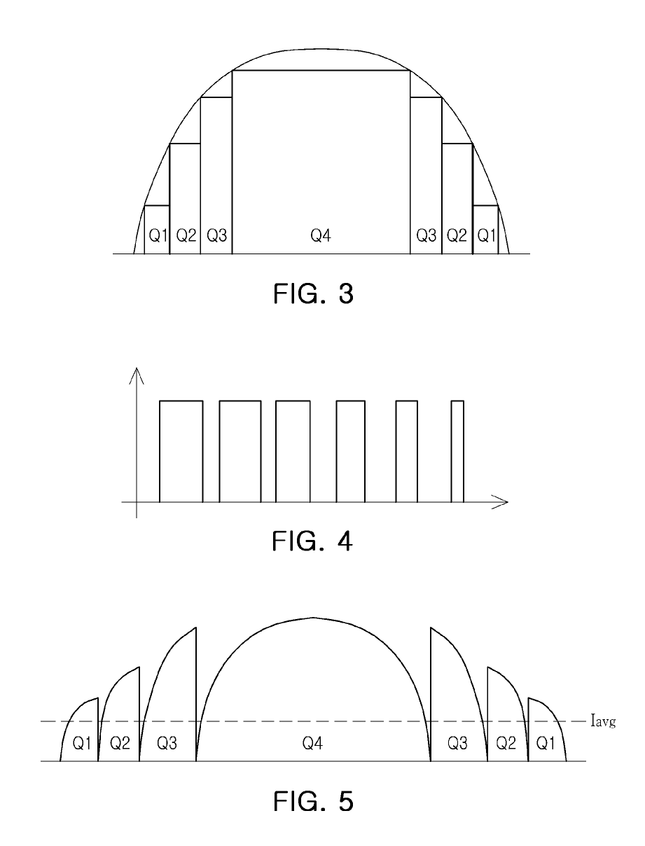

As illustrated in FIG. 3, when an AC signal that is gradually increased and is then decreased in a sine wave form is applied to the light emitting unit 230 from the rectifying unit 220, the operation of the plurality of LEDs included in the light emitting unit 230 is determined according to a level of the AC signal. For example, when a low level AC signal is applied, since power is not enough to drive all four LEDs, the switching element Q1 is turned on and all the remainder, the switching elements Q2 to Q4 are turned off as illustrated in FIG. 2. Accordingly, since the AC signal output by the rectifying unit is transferred through a path including the LED D1, the switching element Q1, and a resistor R1, only the LED D1 is turned on and all the remainder, the LEDs D2 to D4 are turned off.

Thereafter, when the level of the AC signal is gradually increased, the switching elements Q1, Q3, and Q4 are turned off and the switching element Q2 is turned on. In this case, the LEDs D1 and D2 are turned on and the LEDs D3 and D4 are turned off, and the AC signal is transferred to a path including the turned-on switching element Q2 and a resistor R2. As described above, the switching elements Q1 to Q4 are sequentially turned on one by one, and the switching elements Q4 to Q1 are sequentially turned on one by one again, and as a result, the LEDs may be directly driven by the AC signal without the AC-DC converter.

The turned-on switching element may be consistently turned on within a time when the corresponding switching element needs to be turned on (linear method) or may repeat an on/off operation at a high frequency within a time when the corresponding switching element needs to be turned on (PWM method). In the case of the PWM method, the on/off operation of the switching elements may be determined by duty ratios of the control signals S1 to S4 applied to the switching elements. In this case, when a control signal having a constant duty ratio is applied to the turned-on switching element, the maximum current higher than average current may instantaneously flow in the LED connected to the corresponding switching element, and as a result, current stress on the LED may be increased. Hereinafter, this will be described with reference to FIG. 4.

FIG. 4 is a graph schematically illustrating current flowing in the LED when a control signal having a constant duty ratio is applied to the switching elements Q1 to Q4. In a first period in which the switching element Q1 is turned on, the maximum current relatively higher than average current Iavg appears. This happens in respective periods in which the switching elements Q2 to Q4 are turned on. This is because the level of the AC signal applied to the LED D1 is higher at a point just before the switching element Q1 is turned off after the turning-on period ends than at a point when the switching element Q1 is turned on.

Accordingly, the LED D1 needs to use an LED enough to withstand the maximum current higher than the average current Iavg, that is, having a high current limit, and as a result, manufacturing costs are entirely increased. Further, the maximum current higher than the average current appears and many ripple components exist therein, thereby deteriorating the stability of the entire system.

In the embodiment of the present invention, in order to solve the problem, as illustrated in FIG. 5, control signals having different duty ratios are applied to the switching elements, respectively. FIG. 5 is a graph schematically illustrating the control signal S1 applied to the switching element Q1, in the first period of FIG. 4 in which the switching element Q1 is turned on. Referring to FIG. 5, the control signal S1 has a relatively high duty ratio in the early turning-on period in which the level of the AC signal is low, while the control signal S1 has a relatively low duty ratio in the late turning-on period in which the level of the AC signal is gradually increased.

That is, when the level of the input AC signal is low, a conduction time of the switching element Q1 is increased, and thus output current is increased. As the level of the AC signal is gradually increased, the conduction time of the switching element Q1 is shortened, and thus the output current is decreased. In this case, since the ripple components are relatively decreased in an average value of the output current and a difference between the average current and the maximum current may also be decreased, the circuit may be configured using an LED having a relatively low current limit.

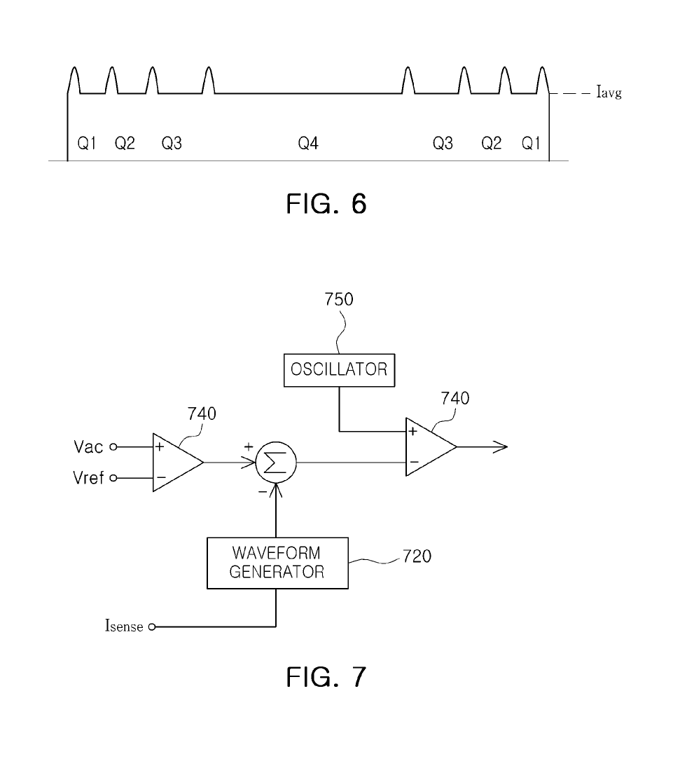

FIG. 6 is a graph schematically illustrating a waveform of current flowing in the LED within a single cycle of the AC signal output by the rectifying unit 220, when a control signal having a duty ratio in inverse proportion to the level of the AC signal is applied, as illustrated in FIG. 5. As illustrated in FIG. 6, the maximum current has a reduced difference as compared with the average current in respective periods in which switching elements Q1, Q2, Q3, Q4, Q3, Q2, and Q1 are sequentially turned on. Accordingly, the ripple components in the current are decreased, and as a result, the circuit may be configured using an LED having a low current limit.

The turning-on and turning-off operations of the switching elements Q1 to Q4 included in the switching unit 240 is determined according to the level of the AC signal output by the rectifying unit 220. Further, the duty ratio of the control signal applied to the turned-on switching element is also determined according to the level of the AC signal within the turning-on period. Accordingly, the controlling unit may detect the level of the AC signal output by the rectifying unit 220, determine which switching element is turned on among the plurality of switching elements Q1 to Q4 based on the detected level, and determine the duty ratio of the control signal applied to the turned-on switching element in the PWM method. Hereinafter, an example of a circuit configuration of the controlling unit will be described with reference to FIG. 7.

FIG. 7 is a circuit diagram illustrating an example of a controlling unit of an LED driving apparatus according to an embodiment of the present invention in detail.

Referring to FIG. 7, a controlling unit of the LED driving apparatus according to the present embodiment includes a comparator 710 comparing a level Vac of an AC signal with a predetermined reference voltage Vref, a waveform generator 720 generating a waveform by detecting current Isense flowing in an LED, a calculator 730 calculating outputs of the comparator 710 and the waveform generator 720, and a control signal generator 740 generating a control signal based on outputs of an oscillator 750 and the calculator 730.

Referring to FIG. 7, when a difference between the level Vac of the AC signal and the reference voltage Vref is increased, a control signal having a relatively low duty ratio is output from the control signal generator 740. In this case, the current Isense flowing in the LED is reflected in the generating process of the control signal, and as the current Isense flowing in the LED is increased, the control signal having the low duty ratio is output, and thus, an error from the average current is minimized.

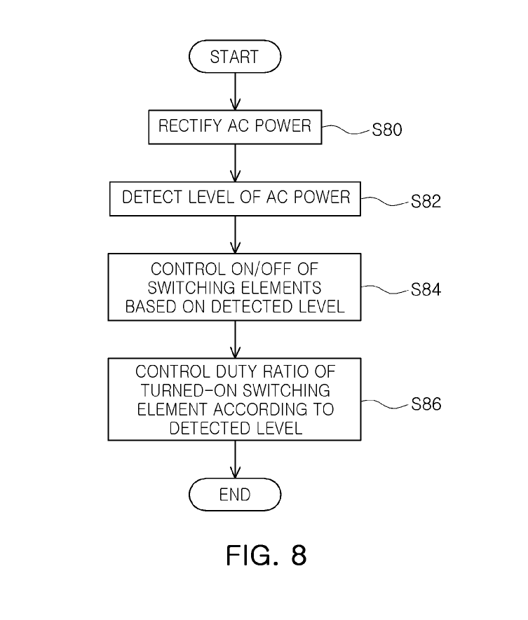

FIG. 8 is a flowchart illustrating an LED driving method according to an embodiment of the present invention.

Referring to FIG. 8, in an LED driving method according to the present embodiment, AC power is rectified (S80). The rectified AC signal is directly applied to the light emitting unit 130 as a driving signal without passing through an AC-DC converter, and the controlling unit 150 detects a level of the rectified AC signal (S82).

The controlling unit 150 controls on and off of the switching elements based on the detected level. As illustrated in FIG. 3, the level of the AC signal may be repeatedly increased and decreased within a single cycle, and one of the plurality of switching elements may be turned on and the remainder of the switching elements may be turned off according to the level of the AC signal.

When a specific switching element is turned on, the controlling unit 150 generates a control signal for controlling the corresponding switching element by a PWM method. In this case, the controlling unit 150 may determine a duty ratio of the control signal based on the detected level of the AC signal in operation S82. As described above, when the control signal having a constant duty ratio is applied to the switching element to be turned on, the maximum current relatively higher than the average current is applied to the LED, thereby increasing current stress.

Accordingly, the control signal having a duty ratio inversely proportional to the detected level of the AC signal in operation S82 is applied to the switching element to be turned on, an average current having a small change range may be obtained. As a result, the current stress applied to the LED may be reduced and the circuit may be configured using the LED having a relatively low current limit, whereby an increase in manufacturing costs may be prevented.

As set forth above, according to embodiments of the present invention, LEDs are directly driven by AC power without an AC-DC converter, by determining respective on/off operations of a plurality of switching elements connected to the plurality of LEDs according to a level of the AC power. Further, a duty ratio of a turned-on switching element is controlled according to the level of the AC power, such that ripple components in current flowing in the LED are minimized to reduce current stress applied to the LED. Therefore, a circuit can be configured using an LED having a low current limit, whereby manufacturing costs may be reduced.

While the present invention has been shown and described in connection with the embodiments, it will be apparent to those skilled in the art that modifications and variations can be made without departing from the spirit and scope of the invention as defined by the appended claims.

What is claimed is:

1. An LED driving apparatus, comprising:
a rectifying unit rectifying AC power;
a light emitting unit including a plurality of light emitting diodes;
a switching unit including a plurality of switching elements connected to the plurality of light emitting diodes; and
a controlling unit controlling operations of the plurality of light emitting diodes,
wherein the controlling unit controls a duty ratio of a turned-on switching element based on a level of the AC power within respective turning-on periods of the plurality of switching elements.

2. The LED driving apparatus of claim 1, wherein the controlling unit controls respective turning-on and turning-off operations of the plurality of switching elements based on the level of the AC power.

3. The LED driving apparatus of claim 1, wherein the plurality of switching elements are connected to respective cathodes of the plurality of light emitting diodes.

4. The LED driving apparatus of claim 1, wherein the controlling unit controls the remainder of the plurality of switching elements to be turned off when one of the plurality of switching elements is turned on, and
the controlling unit controls the duty ratio of the turned-on switching element to be inversely proportional to the level of the AC power.

5. The LED driving apparatus of claim 1, wherein the controlling unit includes:
a comparator comparing the level of the AC power with a predetermined reference voltage;
a calculator calculating a current detection signal obtained by detecting current flowing in the plurality of light emitting diodes and an output signal of the comparator; and
a control signal generator generating respective control signals for the plurality of switching elements based on the calculated result of the calculator.

6. The LED driving apparatus of claim 5, wherein the control signal generator generates a control signal having a low duty ratio when the level of the AC power is increased, and generates a control signal having a high duty ratio when the level of the AC power is decreased.

7. An LED driving method, comprising:
rectifying AC power;
detecting a level of the rectified AC power;
controlling respective turning-on and turning-off operations of a plurality of switching elements connected to a plurality of light emitting diodes based on the level of the AC power; and
controlling a duty ratio of a turned-on switching element among the plurality of switching elements based on the level of the AC power.

8. The LED driving method of claim 7, wherein in the controlling of the duty ratio, when the level of the AC power is increased, the duty ratio is decreased so that a conduction time of the switching element is decreased, and when the level of the AC power is decreased, the duty ratio is increased so that the conduction time of the switching element is increased.

9. The LED driving method of claim 7, wherein in the controlling of the turning-on and turning-off operations, one of the plurality of switching elements is turned on according to the level of the AC power and the remainder of the plurality of switching elements are turned off.

10. The LED driving method of claim 9, wherein in the controlling of the turning-on and turning-off operations, the plurality of switching elements are sequentially turned on according to the level of the AC power.

11. An LED driving apparatus for driving an LED array including a plurality of light emitting diodes driven with AC power, the LED driving apparatus comprising:
a switching unit including a plurality of switching elements connected to a plurality of nodes included in the LED array; and
a controlling unit controlling respective operations of the plurality of switching elements according to a level of the AC power,
wherein the controlling unit controls a duty ratio of a turned-on switching element within respective turning-on periods of the plurality of switching elements.

12. The LED driving apparatus of claim 11, wherein the controlling unit controls the remainder of the plurality of switching elements to be turned off when one of the plurality of switching elements is turned on, and
the controlling unit decreases the duty ratio of the turned-on switching element when the level of the AC power is increased, and increases the duty ratio of the turned-on switching element when the level of the AC power is decreased.

13. The LED driving apparatus of claim 11, wherein the controlling unit controls the respective operations of the plurality of switching elements such that the plurality of switching elements are sequentially turned on.

14. The LED driving apparatus of claim 11, wherein the controlling unit includes:
a comparator comparing the level of the AC power with a predetermined reference voltage;
a calculator calculating a current detection signal obtained by detecting current flowing in the light emitting diodes and an output signal of the comparator; and
a control signal generator generating respective control signals for the plurality of switching elements based on the calculated result of the calculator.
